(19) United States
(12) Patent Application Publication
(10) Pub. No.: US 2015/0266750 A1
(43) Pub. Date: Sep. 24, 2015

(54) SOLAR-POWERED DESALINATION SYSTEM

(71) Applicant: UMM AL-QURA UNIVERSITY, MAKKAH (SA)

(72) Inventor: ADEL M.A.A. DAYEM ABDEEN, MAKKAH (SA)

(73) Assignee: UMM AL-QURA UNIVERSITY, MAKKAH (SA)

(21) Appl. No.: 14/218,902

(22) Filed: Mar. 18, 2014

(51) Int. Cl. C02F 1/14

(52) U.S. Cl. CPC C02F 1/14

(57) ABSTRACT

The solar-powered desalination system includes a double-walled tank, the inner and outer walls defining a condensation chamber therebetween. The lower portion of the tank provides a thermally insulated storage volume for saltwater, and the upper portion forms an evaporation chamber. Warm saltwater is sprayed upward into the evaporation chamber so that the resulting water vapor passes to the top of the tank and down between the two walls, where it condenses. Condensate is drained off by an outlet at the bottom of the condensation chamber between the two tank walls. A solar collector warms the saltwater before it enters the lower part of the tank. No energy is required, as the water circulates due to a thermosiphon effect. The only energy required is to operate the pump for the internal spray system. Optionally, a heating element may be installed in the bottom of the tank.

### BACKGROUND OF THE INVENTION

1. Field of the Invention

The present invention relates generally to water desalination and/or purification systems, and particularly to a solar-powered desalination system using a humidification and dehumidification process.

2. Description of the Related Art

Water that is sufficiently clean for agricultural use and potable for human consumption is an increasingly valuable commodity in many parts of the world, particularly in the Middle East. Increasing population pressures result in an increasing need for water of suitable quality, and natural fresh water supplies are dwindling as they are drawn faster than they are naturally replenished.

As a result, the desalination of seawater has become an increasingly important source of suitable water in many parts of the world. This is particularly true in the Middle East, where natural fresh water is scarce, population pressures are increasing, and the land masses are surrounded by reasonably accessible bodies of seawater. However, desalination of seawater is also a viable means of obtaining fresh water in many other parts of the world. The practicality of such systems depends primarily upon the energy costs involved.

A number of different principles are known for the removal of salt and/or other contaminants from water. Filtration and reverse osmosis have been used for such purposes, but these systems are relatively energy intensive due to the high pressure pumps required (and corresponding energy costs) and the maintenance and replacement costs involved for the filters. Accordingly, evaporation or distillation is generally considered to be a more cost effective means for removing salt and/or other contaminants from seawater. However, the efficiency of such evaporative or distillation systems also depends upon the energy input required, and the cost of obtaining or producing that energy.

Heat is a necessary component of any evaporative desalination system. The warmer the seawater, the greater the rate of evaporation, so heat input is required to produce any reasonably efficient evaporative system. The heat may be produced in a number of different ways, from the burning of combustive fuels to electrical energy from various sources, e.g., fossil fuel plants, nuclear energy, hydroelectric energy, etc. The primary factor that all of these energy sources have in common at the consumer level is their cost. While it may be possible to construct a reasonably inexpensive desalination apparatus, the cost of energy to operate the system may be prohibitive.

Thus, a solar-powered desalination system solving the aforementioned problems is desired.

### SUMMARY OF THE INVENTION

The solar-powered desalination system includes a multifunctional tank that serves as both a storage volume for incoming saltwater and as the evaporation and condensation chambers for the purification of the saltwater contained in the storage volume. The tank is preferably installed aboveground, having an outer surface exposed to the ambient air. The tank has a double wall construction defining a condensation chamber or volume between the inner and outer walls. The lower part of the tank is thermally insulated between the walls in order to retain heat input to the saltwater contained therein. The chamber or volume between the two walls is open in the upper part of the tank, and serves as a condensation chamber for water evaporated from the liquid in the lower portion of the tank.

A spray system is installed in the tank above the liquid storage portion of the tank. The spray nozzles are oriented upward to maximize the time that spray droplets spend in the air within the tank, thereby maximizing evaporation. The evaporated water passes to the top of the tank and downward between the inner and outer walls in the upper portion of the tank, where relatively cooler temperatures result in condensation of the water on the inner and outer walls of the tank. The condensed pure water runs down the walls of the tank where it is drained off by an outlet immediately above the insulated lower portion of the tank. The saltwater supply is replenished by a saltwater inlet to the lower portion of the tank that is controlled by a float mechanism in the bottom of the tank.

A solar collector is installed in series with the water supply in the lower portion of the tank. The solar collector circulates saltwater therethrough from the lower portion of the tank. The water circulation is due to a thermosiphon effect, wherein water warmed in the collector rises to the top of the collector to pass to the lower portion of the tank, and cooler water that has collected in the bottom of the tank flows back to the collector. Thus, the only energy required in addition to the solar input is for the operation of the pump for the spray system within the tank, and optionally for an auxiliary heater in the bottom of the tank.

These and other features of the present invention will become readily apparent upon further review of the following specification and drawings.

### BRIEF DESCRIPTION OF THE DRAWINGS

FIG. 1 is a perspective view of a solar-powered desalination system according to the present invention, illustrating its various features.

FIG. 2 is an elevation view in section of the solar-powered desalination system according to the present invention, illustrating additional internal features.

FIG. 3 is a bar graph showing the production of desalinated water using the solar-powered desalination system according to the present invention.

FIG. 4 is a graph showing desalinated water production output versus incoming water temperature of the solar-powered desalination system according to the present invention.

Similar reference characters denote corresponding features consistently throughout the attached drawings.

### DETAILED DESCRIPTION OF THE PREFERRED EMBODIMENTS

The solar-powered desalination system combines a water storage tank with evaporator and condenser components in a single unit. While the system may include an electrically powered heating element in the water storage tank, the system preferably operates by means of a solar collector disposed external to the tank and water flowing between the solar collector and the tank due to thermosiphon effect. In this manner, the only electrical power required is to drive the pump for the internal spray system for water evaporation in the upper portion of the tank, unless the optional electric heating element is used.

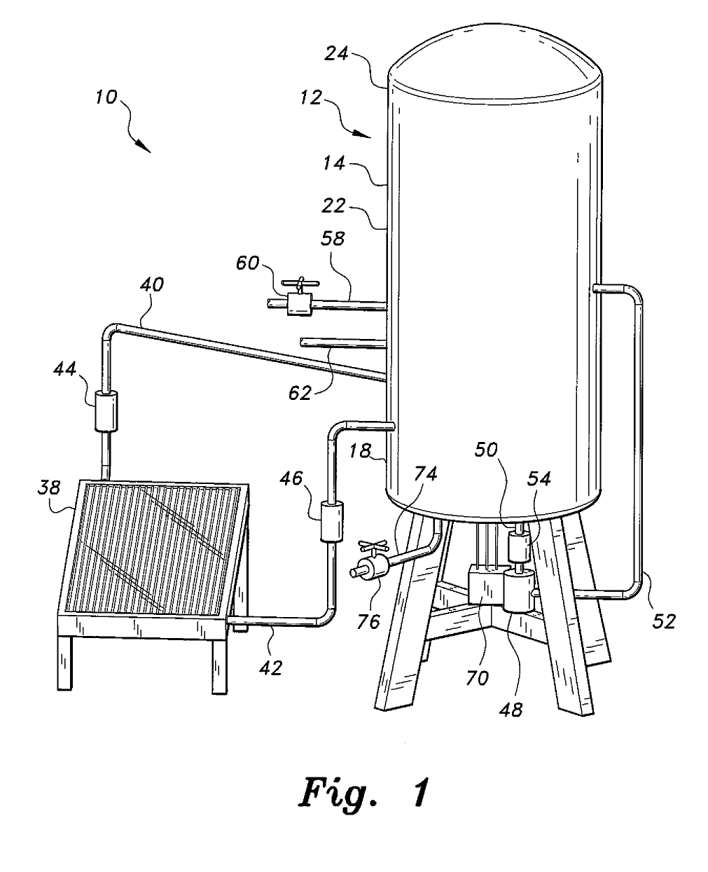

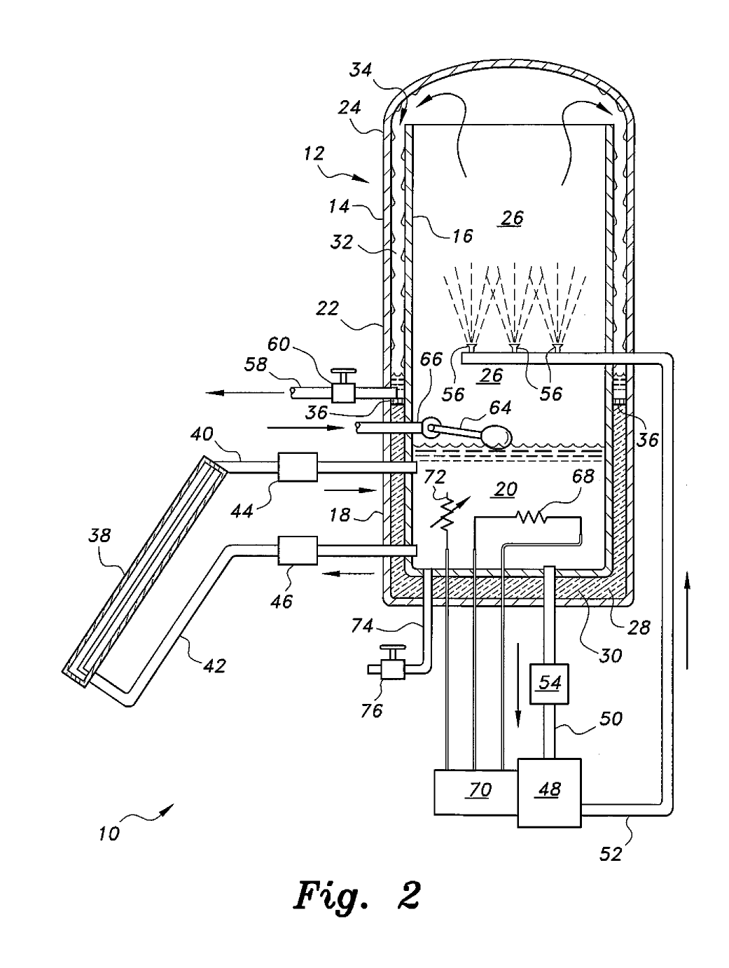

FIGS. 1 and 2 of the drawings illustrate an external perspective view and an elevation view in section, respectively, of the solar-powered desalination system 10. The desalination system 10 includes a tank 12 having a closed outer wall 14 and an inner wall 16 within the outer wall 14, the inner wall 16 and other internal components being shown in the section view of FIG. 2. The tank 12 comprises a lower portion 18 that generally serves as the liquid water storage chamber 20 of the system, an intermediate portion 22, and an upper portion 24. The intermediate and the upper portions 22 and 24 within the inner wall 16 serve as the evaporation chamber 26 of the system 10. The outer and inner walls 14 and 16 define an annular space or volume therebetween. The volume 28 in the lower portion 18 of the tank 12 between the outer and inner walls 14 and 16 contains thermal insulation 30, e.g., glass fiber batting, etc. The annular space or volume of the intermediate and upper portions 22 and 24 between the outer and inner walls 14 and 16 serves as the condensation chamber or volume 32 of the system 10. The evaporation chamber 26 and the condensation chamber 32 communicate with one another through the open upper end 34 of the inner wall 16. A waterproof seal 36 is installed between the thermally insulated volume 28 and the condensation chamber 32 between the two walls 14 and 16.

A solar collector 38 is disposed external to the tank 12. The collector 38 communicates with the tank 12 by means of a water inlet line 40 extending from the collector 38 to the water chamber 20 of the tank 12 and a water outlet line 42 extending from the water chamber 20 back to the collector 38. Saltwater is heated by the sun in the collector 38. The heated water rises in the collector 38 to flow through the upper water inlet line 40 to the water storage chamber 20 in the lower portion 18 of the tank 12. The water within the chamber 20 will cool to a temperature cooler than the heated water from the collector 38. The cooler water settles to the bottom of the chamber 20 due to thermal convection. The cooler water flows through the outlet line 42 and back to the collector 38, where it is reheated by the sun. This circulation is entirely due to a thermosiphon effect, so that no powered pumping action is required. However, a check valve 44 may be installed in the inlet line from the collector 38 to the chamber 20 to prevent backflow. A filter may also be installed in the collector circuit, e.g., the filter 46 disposed in the outlet line 42 to prevent contaminants from flowing from the chamber 20 into the collector 38.

It will be seen that the relatively warm water being supplied to the water storage chamber 20 in the lower portion of the tank 12 will tend to evaporate due to the correspondingly higher vapor pressure. Evaporation is facilitated by a spray system comprising a water pump 48 external to the tank 12 that draws water from the storage chamber 20 by means of a water supply line 50 extending from the water storage chamber 20 to the pump 48 and a water delivery line 52 extending from the pump 48 to the evaporation chamber 26 in the intermediate portion 22 of the tank 12. A filter 54 is preferably installed in the water supply line 50 between the water storage chamber 20 of the tank 12 and the external water pump 48. The water delivery line 52 terminates in a plurality of spray nozzles 56 that are directed upward to spray the saltwater up into the evaporation chamber 26 of the upper portion 24 of the tank 12. While three nozzles 56 are shown distributed along a generally diametric pipe, it will be seen that more or fewer nozzles may be incorporated in any array configuration as desired. In this manner, the saltwater droplets distributed from the nozzles 56 are sent upward in the evaporation chamber 26 before falling. This atomizes the saltwater, increases the surface area and the residence time in the evaporation chamber 26, thus increasing evaporation of water from the droplets.

The water vapor resulting from the above system rises to the upper portion of the evaporation chamber 26, where it begins to condense upon the inner surface of the top of the outer wall and also to descend into the annular condensation chamber or volume 32 between the outer and inner walls 14 and 16 of the intermediate and upper portions 22 and 24 of the tank 12. The condensed and purified water forms droplets upon the facing surfaces of the two walls 14 and 16 of the condensation chamber 32, and runs down those wall surfaces to collect in the bottom portion of the condensation chamber 32 above the seal 36. The purified water is drained from the condensation chamber 32 by an outlet line 58, which may include a shutoff valve 60.

It will be seen that the water supply contained in the water storage chamber 20 will be depleted as water is evaporated from the evaporation chamber 26, condenses in the condensation chamber 32, and is drained from the chamber 32 by the outlet line 58. Accordingly, a water replenishment line 62 is provided from a source of saltwater (not shown) to the upper portion of the water storage chamber 20. Water is maintained at the proper level in the chamber 20 by an automatic float valve 64 installed at the delivery end 66 of the replenishment line 62 in the water storage chamber 20.

The purified water output of the system 10 will depend upon the amount of solar energy received by the collector 38, among other factors. When relatively little solar energy is being received, the water temperature in the water storage chamber 20 will be correspondingly low and the evaporation rate will also be relatively low. Accordingly, an electric heating element 68 may be installed in the water storage chamber 20, if desired. The heating element 68 may receive power from an electrical controller and/or junction box 70, which may also supply and control electrical power to the water pump 48. An electrically controlled thermostat 72 may be installed in the water storage chamber 20 of the tank 12 to communicate with the electrical heating element 68 through the controller and junction box 70. A sediment drain line 74 and shutoff valve 76 are also provided, which extends from the bottom of the water storage chamber 20 of the tank 12.

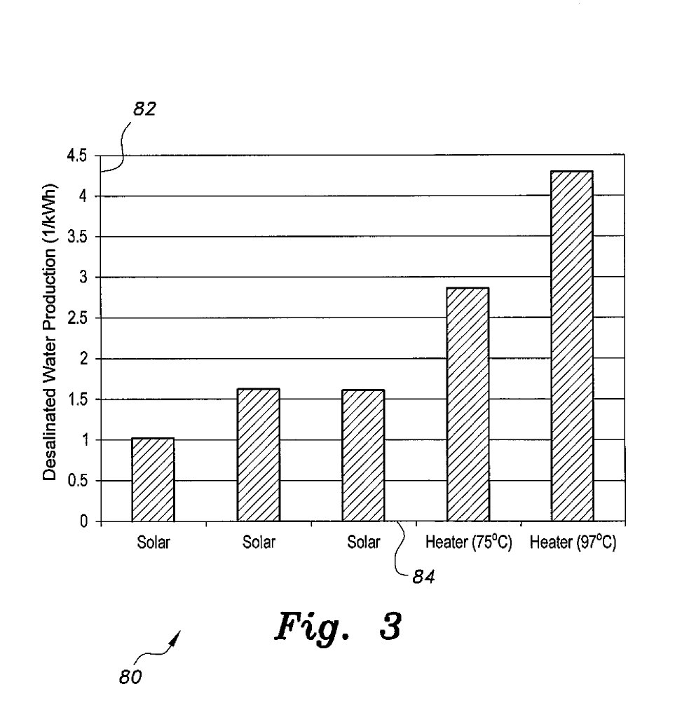

FIG. 3 is a bar graph or chart 80 demonstrating the purified water output per energy input, measured in liters of water per kilowatt hours of energy input. The water production (liters) is shown on the vertical scale 82, and the energy input (either solar or by means of the electric heating element 68, shown in FIG. 2) is shown along the horizontal scale 84. It will be seen that generally an increase in energy input results in a greater output of purified water. The purified water output rises generally as an asymptotic curve due to the ever higher vapor pressure of the water as its heat is increased. According to the graph 80 of FIG. 3, the system 10 may provide on the order of 1.6 liters of purified water per kilowatt hour when receiving only solar power on the collector 38. Greater output of purified water is achieved when the electric heating element is activated, but this may result in somewhat less efficiency overall when the cost of the energy required to heat the element 68 is considered. In any event, the chart or graph 80 will be seen as exemplary for only one specific configuration of the system 10. Variations in the area of the solar collector, the surface area of the tank walls, and other factors of scale result in different efficiencies.

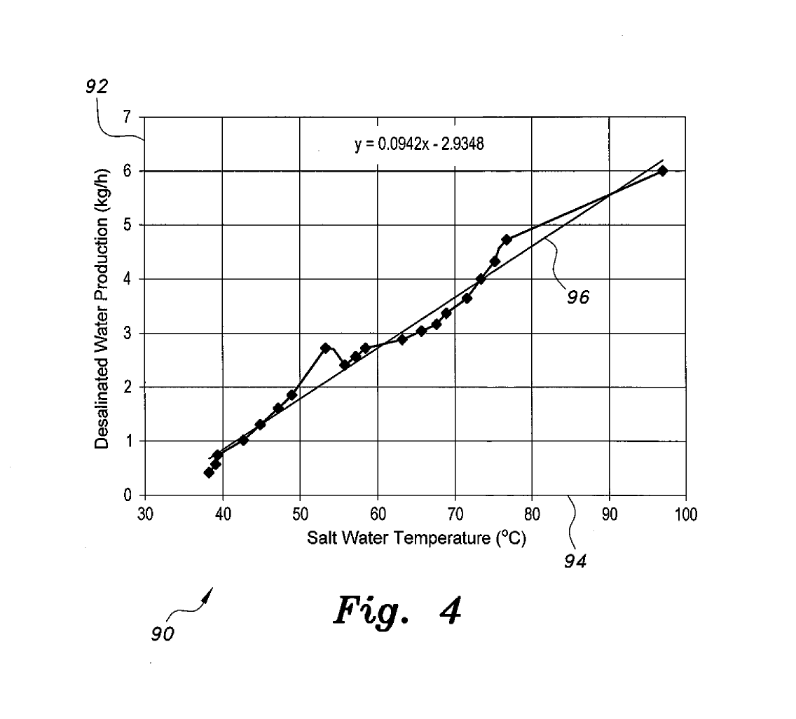

FIG. 4 is a chart or graph 90 showing the production of desalinated or purified water according to the temperature of the saltwater contained in the water storage chamber 20 (FIG. 2 of the drawings). The vertical (y) axis 92 represents the production of desalinated water in kilograms (liters) per hour of system operation, and the horizontal (x) axis 94 represents the saltwater temperature in degrees Celsius as measured in the water storage chamber 20 (FIG. 2). Clearly, the higher the water temperature, the greater the production of desalinated water due to the increase in vapor pressure of the water as it is heated to higher temperatures. The line 96 is an approximation of the relationship between desalinated water output and water temperature. The relationship (line slope) is shown empirically by the equation:

y=0.0942x−2.9348.

The heat gain (temperature rise) from the solar collector 38 (FIGS. 1 and 2) can be determined by the Hottel-Whillier equation:

Qᵤ=A_{c}(F_{R}(τα)Iₜ−F_{R}U_{L}(Tᵢ−Tₐ))=m_{w}C_{ρ}(Tₒ−Tᵢ) (1)

where Qᵤ=heat gain from collector, A_{c}=collector surface area, F_{R}(τα)=collector efficiency, Iₜ=total radiation incident on the collector, F_{R}U_{L}=heat loss coefficient, Tᵢ=inlet temperature at the collector, Tₐ=ambient temperature at the collector, m_{w}=water mass flow rate in the collector, C_{ρ}=water density in the collector, and Tₒ=outlet temperature at collector.

Energy gain (temperature increase) from the water storage chamber of the tank to the evaporation chamber portion of the tank is:

Qₑ=m_{w}C_{ρ}(T_{w}−Tₒ) (2)

where Qₑ=energy gain from tank to evaporator, m_{w}=water mass flow rate in collector, C_{ρ}=water density in the collector, T_{w}=water temperature in the tank, and Tₒ=outlet temperature at the collector.

Heat transfer between the condensed desalinated water and the condenser surface is shown as:

Q₁=M_{d}h_{fg}=Ahₓ(Tₛₐₜ−Tₛ)=Q₂ (3)

Q₂=Ahₓ(Tₛₐₜ−Tₛ) (4)

where Q₁=heat of condensed water in tank, M_{d}=condensate rate, h_{fg}=latent heat of the condensate, A=area of toroidal condensation portion of tank, hₓ=heat transfer coefficient of condensation at a distance x from the surface, Tₛₐₜ=saturation temperature at atmospheric pressure of 100 kPa, deg. Celsius, Tₛ=tank surface temperature (generally about ambient), and Q₂=heat balance of the condenser surface.

In view of the above, hₓ (the heat transfer coefficient of condensation at a distance x from the surface) may be defined as:

$${h}_{x} = {[ \frac{g {ρ}_{L} ( {ρ}_{L} - {ρ}_{v} ) ( {k}^{3} {h}_{fg} )}{4 {μ}_{L} ( {T}_{sat} - {T}_{s} x} ]}^{0.25} \qquad ( 5 )$$

where hₓ=heat transfer coefficient of condensation at a distance x from the surface, g=gravitational constant, ρ_{L}=liquid water density, ρ_{ν}=water vapor density, k=thermal conductivity of the condensate, h_{fg}=latent heat of the condensate, μ_{L}=viscosity of liquid water condensate, Tₛₐₜ=saturation temperature at atmospheric pressure of 100 kPa, deg. Celsius, Tₛ=tank surface temperature (generally about ambient), and x=distance from the surface edge of the tank.

The latent heat of the condensate, h_{fg}, is given by:

h_{fg}=h_{fg}(1+0.68Jₐ) (6)

where:

$${J}_{a} = \frac{{C}_{ρ L} ( {T}_{sat} - {T}_{s} )}{{h}_{fg}} \qquad ( 7 )$$

and where C_{ρ}=water density in the collector, Tₛₐₜ=saturation temperature at atmospheric pressure of 100 kPa, deg. Celsius, and Tₛ=tank surface temperature (generally about ambient).

It will be seen that the solar-powered desalination system according to the present invention is not limited to any specific range of sizes or volumes, but may be scaled up or down to handle an amount of water as desired. The various equations noted above are generally valid, regardless of the size or scale of the system.

It is to be understood that the present invention is not limited to the embodiments described above, but encompasses any and all embodiments within the scope of the following claims.

I claim:

1. A solar-powered desalination system, comprising:
a tank having a closed outer wall and an inner wall disposed within the outer wall, the tank further having a lower portion, a medial portion, and an upper portion;
a water chamber disposed within the inner wall of the lower portion of the tank;
thermal insulation disposed between the outer wall and the inner wall within the lower portion of the tank;
an evaporation chamber disposed within the inner wall of the medial and upper portions of the tank;
a condensation chamber disposed between the outer wall and the inner wall of the medial and the upper portions of the tank, the evaporation chamber and the condensation chamber communicating with one another; and
a waterproof seal disposed between the thermally insulation and the condensation chamber.

2. The solar-powered desalination system according to claim 1, further comprising:
a solar collector disposed external to the tank;
a water inlet line connected between the solar collector and the water chamber;
a water outlet line connected between the water chamber and the solar collector;
a plurality of spray nozzles disposed within the evaporation chamber of the tank;
a water pump disposed external to the tank;
a water supply line disposed between the water chamber and the pump; and
a water delivery line disposed between the pump and the spray nozzles.

3. The solar-powered desalination system according to claim 2, further comprising a check valve disposed in the water inlet line between the solar collector and the water chamber.

4. The solar-powered desalination system according to claim 2, wherein the spray nozzles are oriented upward.

5. The solar-powered desalination system according to claim 1, further comprising an electric heater disposed within the water chamber.

6. The solar-powered desalination system according to claim 5, further comprising a thermostatic control communicating electrically with the electric heater.

7. The solar-powered desalination system according to claim 1, further comprising:
a water replenishment line extending to the water chamber, the water replenishment line having a delivery end disposed within the water chamber; and
a float valve disposed upon the delivery end of the water replenishment line, the float valve selectively controlling water flow from the water replenishment line.

8. A solar-powered desalination system, comprising:
a tank having a closed outer wall and an inner wall disposed within the outer wall, the tank further having a lower portion, a medial portion, and an upper portion;
a water chamber disposed within the inner wall of the lower portion of the tank;
an evaporation chamber disposed within the inner wall of the medial and upper portions of the tank;
a solar collector disposed external to the tank;
a water inlet line connected between the solar collector and the water chamber;
a water outlet line connected between the water chamber and the solar collector;
a plurality of spray nozzles disposed within the evaporation chamber;
a water pump disposed external to the tank;
a water supply line disposed between the water chamber of the tank and the pump; and
a water delivery line disposed between the pump and the spray nozzles.

9. The solar-powered desalination system according to claim 8, further comprising:
thermal insulation disposed between the outer wall and the inner wall of the lower portion of the tank;
a condensation chamber disposed between the outer wall and the inner wall of the medial and upper portions of the tank, the evaporation chamber and the condensation chamber communicating with one another; and
a waterproof seal disposed between the thermal insulation and the condensation chamber.

10. The solar-powered desalination system according to claim 8, further comprising an electric heater disposed within the water chamber.

11. The solar-powered desalination system according to claim 10, further comprising a thermostatic control communicating electrically with the electric heater.

12. The solar-powered desalination system according to claim 8, further comprising a check valve disposed in the water inlet line from the solar collector to the water chamber of the tank.

13. The solar-powered desalination system according to claim 8, wherein the spray nozzles are oriented upward.

14. The solar-powered desalination system according to claim 8, further comprising:
a water replenishment line extending to the water chamber, the water replenishment line having a delivery end disposed within the water chamber; and
a float valve disposed upon the delivery end of the water replenishment line, the float valve selectively controlling water flow from the water replenishment line.

15. A solar-powered desalination system, comprising:
a tank having a closed outer wall and an inner wall disposed within the outer wall, the tank further having a lower portion, a medial portion, and an upper portion;
a water chamber disposed within the inner wall of the lower portion of the tank;
an electric heater disposed within the water chamber;
a thermostatic control communicating electrically with the electric heater; and
an evaporation chamber disposed within the inner wall in the medial and upper portions of the tank.

16. The solar-powered desalination system according to claim 15, further comprising:
thermal insulation disposed between the outer wall and the inner wall in the lower portion of the tank;
a condensation chamber disposed between the outer wall and the inner wall in the medial and upper portions of the tank, the evaporation chamber and the condensation chamber communicating with one another; and
a waterproof seal disposed between the thermal insulation and the condensation chamber.

17. The solar-powered desalination system according to claim 15, further comprising:
a solar collector disposed external to the tank;
a water inlet line connected between the solar collector and the water chamber;
a water outlet line connected between the water chamber and the solar collector;
a plurality of spray nozzles disposed within the evaporation chamber of the tank;
a water pump disposed external to the tank;
a water supply line disposed between the water chamber and the pump; and
a water delivery line disposed between the pump and the spray nozzles.

18. The solar-powered desalination system according to claim 17, further comprising a check valve disposed in the water inlet line from the solar collector to the water chamber of the tank.

19. The solar-powered desalination system according to claim 17, wherein the spray nozzles are oriented upward.

20. The solar-powered desalination system according to claim 15, further comprising:
a water replenishment line extending to the water chamber, the water replenishment line having a delivery end disposed within the water chamber; and
a float valve disposed upon the delivery end of the water replenishment line, the float valve selectively controlling water flow from the water replenishment line.
